(19) United States
(12) Patent Application Publication
(10) Pub. No.: US 2026/0159046 A1
(43) Pub. Date: Jun. 11, 2026

(54) TRUCK COMPRISING A WET BRAKE COOLING SYSTEM

(71) Applicant: Liebherr Mining Equipment Newport News Co., Newport News, VA (US)

(72) Inventor: Joshua Brown, Newport News, VA (US)

(21) Appl. No.: 18/972,274

(22) Filed: Dec. 6, 2024

(51) Int. Cl. B60T 5/00; B60K 6/46; B60L 50/60; B60P 1/04; F16D 55/36; F16D 65/78; F16D 65/853; F16H 57/04

(52) U.S. Cl. CPC B60T 5/00; F16D 55/36; F16D 65/853; F16H 57/0415; F16H 57/0436; B60K 6/46; B60L 50/60; B60L 2200/40; B60P 1/04; B60Y 2200/92; F16D 2065/789

(57) ABSTRACT

The present disclosure provides a truck comprising a plurality of wheels; at least one electric traction motor; at least one traction gear; at least one wet brake; and at least one traction gear cooling circuit. The at least one electric traction motor is configured to drive at least one out of the plurality of wheels via the at least one traction gear and the at least one traction gear cooling circuit is configured to cool the at least one traction gear. Further, the at least one traction gear cooling circuit is further configured to cool the wet brake.

### TECHNICAL FIELD

The present disclosure relates to truck comprising a wet brake cooling system.

### BACKGROUND

The service brakes of a truck may be configured as dry friction brakes or wet friction brakes. A wet brake may in particular be configured as a wet disc brake.

### SUMMARY

In a wet disc brake, there is usually a stack of brake discs, which alternate with brake plates attached to the stator of the brake, and which are immersed in hydraulic fluid. By decreasing the distance between the brake discs and the brake plates, due to the increased shearing forces in the hydraulic fluid, a braking torque is transmitted via the hydraulic fluid, without the discs and the plates actually touching.

In usual wet brakes, at least when used for trucks, the hydraulic fluid in the wet brakes is cooled in a cooling circuit, i.e. the hydraulic fluid is flowing out of the brake into a cooling circuit and cooled in a radiator or heat exchanger included in the cooling circuit before flowing back into the brake. Because the braking may contaminate the oil, such a cooling circuits for the brakes is usually fluidly separate from other cooling circuits of the truck. The wet disc brake cooling system is e.g. cooled by transferring heat to the engine coolant circuit. This involves heat exchangers, pumps, and complex cooling circuits.

The cooling involved with known wet brakes is therefore heavy and involves many components.

An object of the present disclosure is therefore to reduce the weight, cost, and space requirements of the wet brake cooling system while meeting minimum performance criteria.

To address at least some of these objects, in one general aspect, the present disclosure provides a truck that uses the traction gear set mass and traction gear set oil to reject heat. The traction gear set on many OHT trucks already contains a cooling circuit.

In a further general aspect, the present disclosure provides a truck and a wet brake that uses integral cooling channels in the wet disc brake housing.

In a further general aspect, the present disclosure provides a truck and a wet brake that uses external cooling fins on the wet disc brake housing.

These general aspects may be combined or used in isolation.

In a first independent aspect, the present disclosure provides a truck comprising a plurality of wheels; at least one electric traction motor; at least one traction gear; at least one wet brake; and at least one traction gear cooling circuit. The at least one electric traction motor is configured to drive at least one out of the plurality of wheels via the at least one traction gear and the at least one traction gear cooling circuit is configured to cool the at least one traction gear. Further, the at least one traction gear cooling circuit is further configured to cool the wet brake.

Thereby, the cooling circuit of the traction gears is also used to also cool the wet brakes. The hydraulic fluid used for the cooling of the gears, as well as the gears themselves, have a high thermal capacity which can be used for taking up heat generated in the wet brakes. This arrangement utilizes existing systems on the truck for heat rejection.

According to an aspect of the present disclosure, a braking chamber of the at least one wet brake is filled with a first hydraulic fluid and the truck comprises a heat exchanger for cooling the first hydraulic fluid, the heat exchanger being connected to the at least one traction gear cooling circuit. Thereby, the hydraulic fluid of the wet brakes is thermally connected to the hydraulic fluid flowing in the cooling circuit of the traction gears by a heat exchanger. This avoids cross-contamination between the cooling circuits, and makes it possible to use different hydraulic fluids for the wet brake and the traction gears.

According to an aspect of the present disclosure, the at least one traction gear cooling circuit comprises a pump and a coolant heat exchanger, wherein the pump is configured to circulate a second hydraulic fluid through the heat exchanger, the coolant heat exchanger and the at least one traction gear. Thereby, a single cooling circuit is used for cooling the traction gears and the wet brake. In an embodiment, the at least one traction gear comprises a housing containing a gear chamber containing gears, with the second hydraulic fluid flowing through the gear chamber. The coolant heat exchanger may in particular be a coolant-to-air heat exchanger, such as an oil-to-air heat exchanger.

According to an aspect of the present disclosure, the wet brake comprises a housing, the heat exchanger being at least one out of arranged in and integrated into the housing. Thereby, the complexity and size of the cooling system is reduced.

In particular, the first hydraulic fluid of the wet brakes is cooled without guiding the fluid out of the wet brakes and cooling it in a separate heat exchanger.

In a second independent aspect, the present disclosure comprises a truck comprising a plurality of wheels; at least one electric traction motor; and at least one wet brake; wherein the at least one electric traction motor is configured to drive at least one out of the plurality of wheels, wherein a braking chamber of the at least one wet brake is filled with a first hydraulic fluid, wherein the wet brake comprises a housing and a heat exchanger for cooling the first hydraulic fluid, the heat exchanger being at least one out of arranged in and integrated into the housing. Thereby, the complexity and size of the cooling system is reduced.

In an aspect of the present disclosure, the first hydraulic fluid is encapsulated in the housing of the wet brake and is cooled inside the housing. Thereby, the first hydraulic fluid of the wet brakes is cooled without guiding the fluid out of the wet brakes and cooling it in a separate heat exchanger.

The heat exchanger according to the second independent aspect may be connected to any type of cooling circuit. In particular, one might use a separate cooling circuit for the wet brake, or any existing cooling circuit of the truck.

In an embodiment, the first and the second independent aspects of the present disclosure are combined. Thereby, the heat exchanger arranged or integrated in the housing of the wet brake is connected to a cooling circuit of the traction gears.

In a third independent aspect, the present disclosure comprises a wet brake comprising a housing; a braking chamber and a plurality of brake discs arranged in the braking chamber, wherein the braking chamber is filled with a first hydraulic fluid, wherein a heat exchanger for cooling the first hydraulic fluid is at least one out of arranged in and integrated into the housing. The wet brake according to the third aspect has the same advantages already discussed with respect to the second independent aspect, and may be configured as described above with respect to the second independent aspect.

In the following, possible features of truck according to the first and/or second independent aspect, as well as of a wet brake according to the third independent aspect, will be described:

In an embodiment, the first hydraulic fluid may be encapsulated in the housing of the wet brake and is cooled inside the housing.

In an aspect of the present disclosure, the first hydraulic fluid is moved inside the housing via a rotation of brake discs arranged inside the housing and without the use of a pump.

In an embodiment, cooling channels of the heat exchanger are integrated into the housing, the cooling channels being connected to the at least one traction gear cooling circuit. Therefore, the housing acts as a heat exchanger between the first cooling fluid of the wet brake and the second hydraulic fluid of the cooling circuit of the traction gears.

In an embodiment, the heat exchanger is arranged at a sump of the wet brake arranged inside the housing, the sump configured to hold at least part of the first hydraulic fluid. Thereby, it is equally possible to cool the first fluid.

In an aspect, an outer surface of the housing of the wet brake is provided with cooling fins. Thereby, heat is transferred from the wet brake to ambient air, reducing the cooling requirements that the heat exchanger has to provide.

In an aspect, the truck is a dump truck comprising a dump body pivotably attached to a frame of the dump truck.

In an aspect, the truck is a battery electric truck comprising a battery pack for energizing the at least one traction motor.

In an aspect, the truck is a diesel-electric truck comprising a combustion engine driving a generator for energizing the at least one traction motor.

The wet brake of the present disclosure may be a wet disc brake.

In an embodiment, the wet brake of the present disclosure is arranged at the rear wheels of the truck.

The truck may be an open mining truck.

The truck may have a net capacity of more than 50 metric tons, optionally of more than 100 metric tons.

The present disclosure will now be described with respect to drawings and embodiments.

### BRIEF DESCRIPTION OF THE FIGURES

In the drawings,

FIG. 1 shows an embodiment of a truck of the present disclosure,

FIG. 2 shows an embodiment of a cooling system of a truck and an embodiment of a wet brake of the present disclosure, and

FIGS. 3A and 3B show configurations of a power unit for providing energy for the traction motors of the truck.

### DETAILED DESCRIPTION

The present disclosure provides a novel arrangement to transfer heat from a minimalisticly designed rear wet disc brake system on a truck to the traction gear set, the traction gear set oil and/or ambient air. This arrangement reduces the complexity, cost, weight, and space claim of the brake cooling system to a minimum. This arrangement utilizes existing systems on the truck for heat rejection.

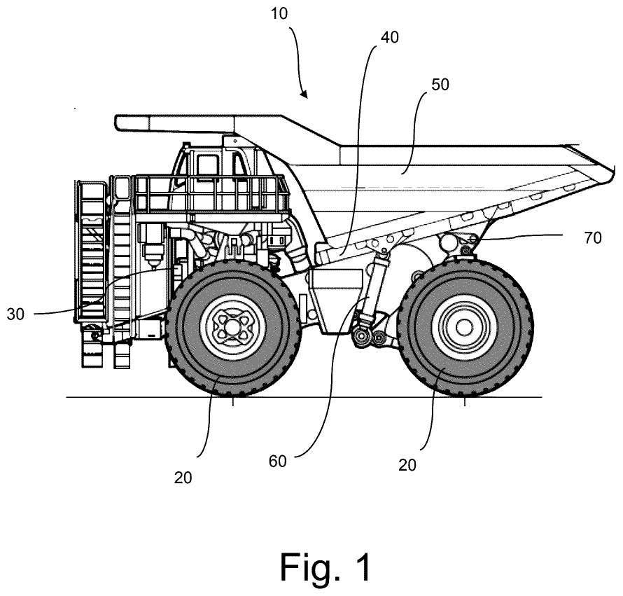

FIG. 1 shows an embodiment of a truck 10 of the present disclosure. The truck 10 comprises wheels 20, at least some of which are driven by an electric traction motor.

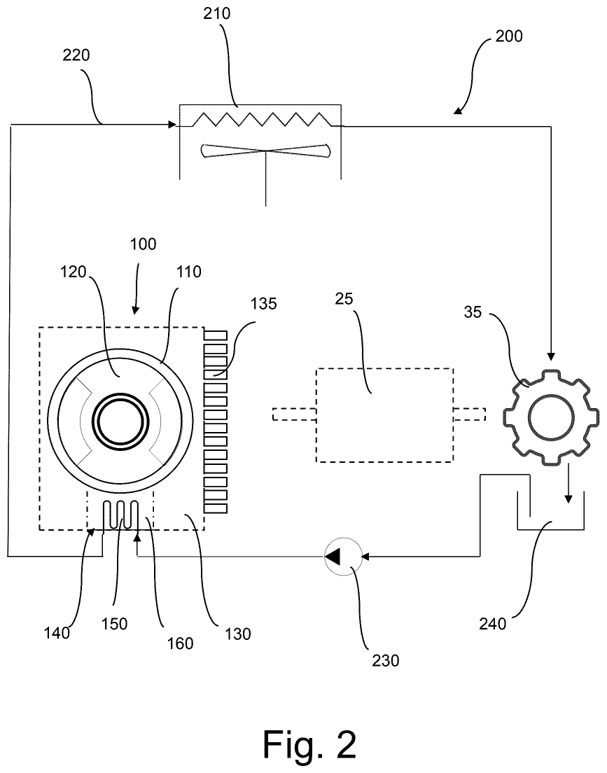

The electric traction motor 25 may drive the wheel or wheels via a traction gear 35, shown schematically in FIG. 2, the traction gear 35 reducing the revolution speed of the electrical traction motor to drive the wheel or wheels.

In an embodiment, at least the two rear wheels may each be driven by an electric traction motor via a traction gear.

Further, at least one of the wheels 20 is operationally coupled to a wet brake 100 for braking the wheel 20. In an embodiment, each of the rear wheels 20 may be provided with a wet brake 100.

The wheels are arranged on a frame 40, with a dump body 50 being pivotably arranged on the frame 40 around a horizontal pivot axis 70, with an actuator, such as a hydraulic cylinder 60, for moving the dump body.

Further, a power unit 30 is arranged on the frame, providing the electrical energy for driving the traction motors.

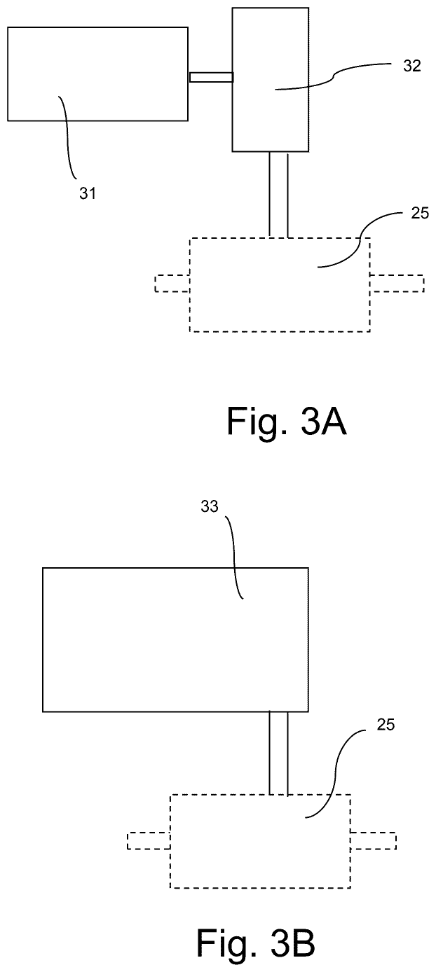

As schematically shown in FIG. 3A, the power unit 30 may comprise a combustion engine 31 driving a generator for generating the electricity to drive the traction motor 25.

As schematically shown in FIG. 3B, the power unit 30 may comprise a battery unit for providing the electricity to drive the traction motor 25. The battery unit may be provided instead of or in addition to the combustion engine and the generator.

The brake 100 comprises a housing enclosing a braking chamber 110 where the braking elements of the brake are arranged. The braking chamber is at least partially filled with hydraulic fluid.

The wet brake 100 may in particular be configured as a wet disc brake. In a wet disc brake, there is a stack of rotating brake discs 120, which alternate with brake plates attached to the stator of the brake, and which are immersed in hydraulic oil in the braking chamber 110. By increasing the clamping force between the brake discs 120 and the brake plates, due to the increased shearing forces in the hydraulic oil, a braking torque is transmitted via the oil, without the discs and the plates actually touching.

Further, the traction gears 35 are provided with a cooling circuit 200 that circulates the hydraulic oil through the gears 35, into sump 240 and via a pump 230 to a coolant-to-air heat exchanger 210 that cools the hydraulic fluid.

The present disclosure provides two new aspects:

The first aspect is to use the cooling circuit 200 of the traction gears 35 to also cool the wet brake 100. The hydraulic fluid used for the cooling of the gears 35, as well as the gears themselves, have a high thermal capacity which can be used for taking up heat generated in the wet brakes.

In order to avoid cross-contamination between the cooling circuits, and in order to be able to use different hydraulic fluids, the hydraulic fluid of the wet brakes 100 is thermally connected to the hydraulic fluid flowing in the cooling circuit of the traction gears 35 by a heat exchanger 140. In particular, a fluid duct 150 of the heat exchanger 140 is connected into a fluid line 220 of the cooling circuit 200 of the traction gears 35 such that the hydraulic fluid flowing through the cooling circuit 200 of the traction gears 35 flows through the heat exchanger, with the heat exchanger fluidly separating the hydraulic fluid of the wet brake 100 from the hydraulic fluid of the traction gear 35.

The second aspect is to cool the hydraulic fluid of the wet brakes 100 without guiding the hydraulic fluid out of the wet brake and cooling it in a separate radiator or heat exchanger. In particular, the disclosure provides cooling ducts 150 integrated in the housing 130 of the wet brake, through which a cooling fluid of a cooling circuit 200 is guided, thereby cooling the hydraulic fluid with in the wet brake 100. Therefore, the housing 130 acts as a heat exchanger between the cooling fluid and the hydraulic fluid of the wet brake. Alternatively, the heat exchanger 140 for cooling the hydraulic oil of the wet brakes could be provided within the oil sump 160 of the wet brake 100.

Thereby, the heat exchanger 140 is integrated in the wet brake. Further, the hydraulic fluid of the wet brakes is moved within the wet brakes by the rotation of the brake discs 120, and thereby cooled by the heat exchanger.

The second aspect could also be used when installing a separate cooling circuit for the wet brakes or using other cooling circuits of the truck. This also includes using water cooling to cool the wet brakes.

In the embodiment, however, it is the cooling circuit 200 of the traction gears that is used to cool the wet brakes 35.

Further, according to a third aspect, cooling fins 135 are arranged on an outer surface of the housing 130 of the wet brake 100 to reject heat to ambient air.

1. A truck comprising:
a plurality of wheels;
at least one electric traction motor;
at least one traction gear;
at least one wet brake; and
at least one traction gear cooling circuit;
wherein the at least one electric traction motor is configured to drive at least one out of the plurality of wheels via the at least one traction gear,
wherein the at least one traction gear cooling circuit is configured to cool the at least one traction gear; and
wherein the at least one traction gear cooling circuit is further configured to cool the wet brake.

2. The truck according to claim 1, wherein a braking chamber of the at least one wet brake is filled with a first hydraulic fluid and the truck comprises a heat exchanger for cooling the first hydraulic fluid, wherein the heat exchanger is connected to the at least one traction gear cooling circuit.

3. The truck according to claim 2, wherein the at least one traction gear cooling circuit comprises a pump and a coolant heat exchanger, wherein the pump is configured to circulate a second hydraulic fluid through the heat exchanger, the coolant heat exchanger and the at least one traction gear.

4. The truck according to claim 2, wherein the wet brake comprises a housing, the heat exchanger being at least one out of arranged in and integrated into the housing.

5. The truck according to claim 4, wherein cooling channels are integrated into the housing, the cooling channels being connected to the at least one traction gear cooling circuit.

6. The truck according to claim 4, wherein the heat exchanger is arranged at a sump of the wet brake arranged inside the housing, the sump configured to hold at least part of the first hydraulic fluid.

7. A truck comprising
a plurality of wheels;
at least one electric traction motor; and
at least one wet brake;
wherein the at least one electric traction motor is configured to drive at least one out of the plurality of wheels,
wherein a braking chamber of the at least one wet brake is filled with a first hydraulic fluid,
wherein the wet brake comprises a housing and a heat exchanger for cooling the first hydraulic fluid, the heat exchanger being at least one out of arranged in and integrated into the housing.

8. The truck of claim 7, wherein the first hydraulic fluid is encapsulated in the housing of the wet brake and is cooled inside the housing.

9. The truck of claim 7, wherein the first hydraulic fluid is moved inside the housing via a rotation of brake discs arranged inside the housing and without use of a pump.

10. The truck according to claim 7, wherein cooling channels of the heat exchanger are integrated into the housing.

11. The truck according to claim 7, wherein the heat exchanger is arranged at a sump of the wet brake arranged inside the housing, the sump configured to hold at least part of the first hydraulic fluid.

12. The truck of claim 1, wherein the truck is a dump truck comprising a dump body pivotably attached to a frame of the dump truck.

13. The truck of claim 1, wherein the truck is a battery electric truck comprising a battery pack for energizing the at least one electric traction motor.

14. The truck of claim 1, wherein the truck is a diesel-electric truck comprising a combustion engine driving a generator for energizing the at least one electric traction motor.

15. The truck of claim 7, wherein an outer surface of the housing of the wet brake is provided with cooling fins.

16. A wet brake comprising
a housing;
a braking chamber and
a plurality of brake discs arranged in the braking chamber,
wherein the braking chamber is filled with a first hydraulic fluid,
wherein a heat exchanger for cooling the first hydraulic fluid is at least one out of arranged in and integrated into the housing.

17. The wet brake of claim 16, wherein an outer surface of the housing is provided with cooling fins.

18. The wet brake of claim 16, wherein the first hydraulic fluid is encapsulated in the housing of the wet brake and is cooled inside the housing, wherein the first hydraulic fluid is moved inside the housing via a rotation of brake discs arranged inside the housing and without use of a pump.

19. The wet brake according to claim 16, wherein cooling channels of the heat exchanger are integrated into the housing.

20. The wet brake according to claim 16, wherein the heat exchanger is arranged at a sump of the wet brake arranged inside the housing, the sump configured to hold at least part of the first hydraulic fluid.
